(19) United States
(12) Patent Application Publication
(10) Pub. No.: US 2010/0177458 A1
(43) Pub. Date: Jul. 15, 2010

(54) CAPACITOR FOR FILTERED FEEDTHROUGH WITH CONDUCTIVE PAD

(75) Inventor: Rajesh V. Iyer, Eden Prairie, MN (US)

Correspondence Address: MEDTRONIC, INC., 710 MEDTRONIC PARKWAY NE, MINNEAPOLIS, MN, 55432-9924, US

(73) Assignee: Medtronic, Inc., Minneapolis, MN (US)

(21) Appl. No.: 12/351,946

(22) Filed: Jan. 12, 2009

(51) Int. Cl. H01G 4/35; H01G 7/00

(52) U.S. Cl. 361/302; 29/25.41

(57) ABSTRACT

A filtered feedthrough assembly includes a capacitor comprising a top portion, a bottom portion, an outer diameter portion and an inner diameter portion. The inner diameter portion defines at least one aperture extending from the top portion to the bottom portion. An conductive pad of conductive material is applied to the top portion around the at least one aperture. A feedthrough pin extends through each of the apertures and is soldered to the inner diameter portion of the capacitor by application of a solder preform upon the conductive pad of conductive material.

### FIELD

The present disclosure relates to electrical feedthroughs for implantable medical devices and, more particularly, an improved capacitor assembly for a filtered feedthrough.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Electrical feedthroughs serve the purpose of providing an electrical circuit path extending from the interior of a hermetically sealed container to an external point outside the container. A conductive path is provided through the feedthrough by a conductor pin which is electrically insulated from the container. Many feedthroughs are known in the art that provide the electrical path and seal the electrical container from its ambient environment. Such feedthroughs typically include a ferrule, the conductor pin or lead and a hermetic glass or ceramic seal which supports the pin within the ferrule. Such feedthroughs are typically used in electrical medical devices such as implantable pulse generators (IPGs). It is known that such electrical devices can, under some circumstances, be susceptible to electromagnetic interference (EMI). At certain frequencies for example, EMI can inhibit pacing in an IPG. This problem has been addressed by incorporating a capacitor structure within the feedthrough ferrule, thus shunting any EMI at the entrance to the IPG for high frequencies. This has been accomplished with the aforementioned capacitor device by combining it with the feedthrough and incorporating it directly into the feedthrough ferrule. Typically, the capacitor electrically contacts the pin lead and the ferrule.

Many different insulator structures and related mounting methods are known in the art for use in medical devices wherein the insulator structure also provides a hermetic seal to prevent entry of body fluids into the housing of the medical device. The feedthrough terminal pins, however, are connected to one or more lead wires which effectively act as an antenna and thus tend to collect stray or electromagnetic interference (EMI) signals for transmission to the interior of the medical device. In some prior art devices, ceramic chip capacitors are added to the internal electronics to filter and thus control the effects of such interference signals. This internal, so-called “on-board” filtering technique has potentially serious disadvantages due to intrinsic parasitic resonances of the chip capacitors and EMI radiation entering the interior of the device housing.

In another and normally preferred approach, a filter capacitor is combined directly with a terminal pin assembly to decouple interference signals to the housing of the medical device. In a typical construction, a coaxial feedthrough filter capacitor is connected to a feedthrough assembly to suppress and decouple undesired interference or noise transmission along a terminal pin.

So-called discoidal capacitors having two sets of electrode plates embedded in spaced relation within an insulative substrate or base typically form a ceramic monolith in such capacitors. One set of the electrode plates is electrically connected at an inner diameter surface of the discoidal structure to the conductive terminal pin utilized to pass the desired electrical signal or signals. The other or second set of electrode plates is coupled at an outer diameter surface of the discoidal capacitor to a cylindrical ferrule of conductive material, wherein the ferrule is electrically connected in turn to the conductive housing or case of the electronic instrument.

In operation, the discoidal capacitor permits passage of relatively low frequency electrical signals along the terminal pin, while shunting and shielding undesired interference signals of typically high frequency to the conductive housing. Feedthrough capacitors of this general type are commonly employed in implantable pacemakers, defibrillators and the like, wherein a device housing is constructed from a conductive biocompatible metal such as titanium and is electrically coupled to the feedthrough filter capacitor. The filter capacitor and terminal pin assembly prevent interference signals from entering the interior of the device housing, where such interference signals might otherwise adversely affect a desired function such as pacing or defibrillating.

In the past, feedthrough filter capacitors for heart pacemakers and the like have typically been constructed by preassembly of the discoidal capacitor with a terminal pin subassembly which includes the conductive terminal pin and ferrule. More specifically, the terminal pin subassembly is prefabricated to include one or more conductive terminal pins supported within the conductive ferrule by means of a hermetically sealed insulator ring or bead. See, for example, the terminal pin subassemblies disclosed in U.S. Pat. Nos. 3,920,888, 4,152,540; 4,421,947; and 4,424,551. The terminal pin subassembly thus defines a small annular space or gap disposed radially between the inner terminal pin and the outer ferrule. A small discoidal capacitor of appropriate size and shape is then installed into this annular space or gap, in conductive relation with the terminal pin and ferrule, e.g., by means of soldering or conductive adhesive. The thus-constructed feedthrough capacitor assembly is then mounted within an opening in the pacemaker housing, with the conductive ferrule in electrical and hermetically sealed relation in respect of the housing, shield or container of the medical device.

Although feedthrough filter capacitor assemblies of the type described above have performed in a generally satisfactory manner, the manufacture and installation of such filter capacitor assemblies has been relatively costly and difficult. For example, installation of the discoidal capacitor into the small annular space between the terminal pin and ferrule can be a difficult and complex multi-step procedure to ensure formation of reliable, high quality electrical connections. Moreover, installation of the capacitor at this location inherently limits the capacitor to a small size and thus also limits the capacitance thereof. Similarly, subsequent attachment of the conductive ferrule to the pacemaker housing, typically by welding or brazing processes or the like, can expose the fragile ceramic discoidal capacitor to temperature variations sufficient to create the risk of capacitor cracking and failure. As described above, a solder, e.g., in the form of a solder preform, may be used to connect the terminal pins with the capacitor. Unfortunately, solder preforms are susceptible to oxidation that may affect the conductivity of the solder and the ability to make a good electrical connection between the pin and the capacitor. Current manufacturing techniques utilize a chemical etching process to remove the formed oxide layers, adding an additional step and expense to the manufacturing process.

There exists, therefore, a significant need for improvements in feedthrough filter capacitor assemblies of the type used, for example, in implantable medical devices such as heart pacemakers and the like, wherein the filter capacitor is designed for relatively simplified and economical, yet highly reliable, installation. In addition, there exists a need for an improved feedthrough assembly that provides reliable and economical electrical connections between the capacitor and feedthrough pins without performing a chemical etching or other process to remove oxide layers from the solder preforms. The present disclosure fulfills these needs and provides further advantages.

### SUMMARY

In various embodiments of the present disclosure, a filtered feedthrough assembly is disclosed. The assembly includes a capacitor that has a top portion, a bottom portion, an outer diameter portion and an inner diameter portion. The inner diameter portion defines at least one aperture extending from the top portion to the bottom portion. The capacitor further includes a conductive pad of conductive material that is applied to the top portion around the at least one aperture. At least one feedthrough pin extends through the at least one aperture and is soldered to the inner diameter portion of the capacitor by application of a solder preform upon the conductive pad of conductive material.

In various alternative embodiments of the present disclosure, a method of manufacturing a filtered feedthrough assembly is disclosed. The method includes applying a conductive pad of conductive material to a capacitor, in which the capacitor includes a top portion, a bottom portion, an outer diameter portion and an inner diameter portion. The inner diameter portion defines at least one aperture extending from the top portion to the bottom portion. The conductive pad of conductive material is applied to the top portion around the at least one aperture. The method further includes extending a feedthrough pin through the at least one aperture, placing a solder preform upon the conductive pad of conductive material, and soldering the feedthrough pin to the inner diameter portion of the capacitor with the solder preform.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1 is an exploded view of a capacitor feedthrough assembly according to various embodiments of the present disclosure;

FIG. 2 is a perspective view of a capacitor according to various embodiments of the present disclosure;

FIG. 3 is a top view of the capacitor of FIG. 2;

FIG. 4 is a cross-sectional view of the capacitor of FIG. 2 taken along line 4-4; and

FIG. 5 is a perspective view of a capacitor and associated conductive pads according to various embodiments of the present disclosure.

### DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

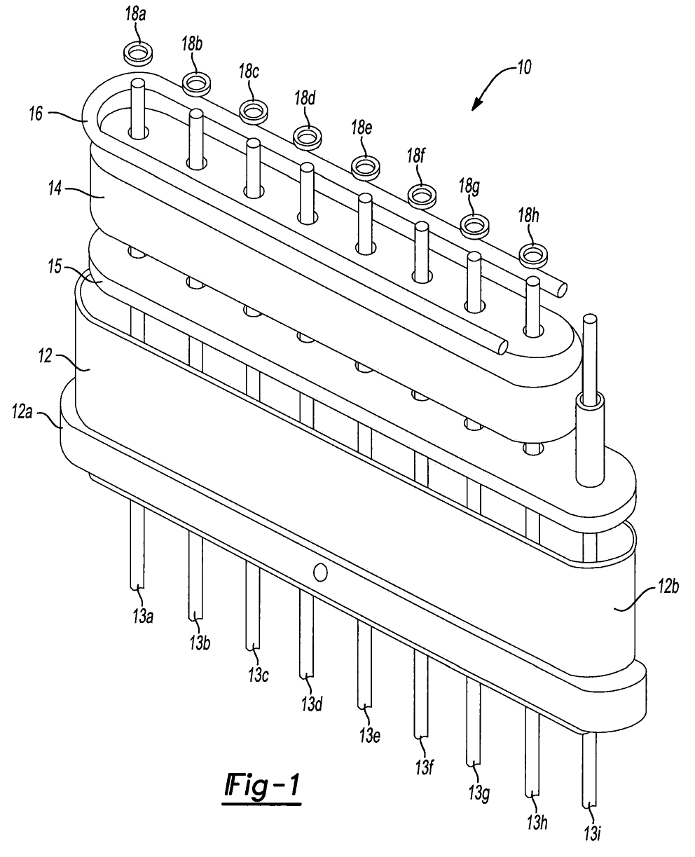

Referring now to FIG. 1, an exploded view of a capacitor feedthrough assembly 10 according to various embodiments of the present disclosure is illustrated. The assembly 10 comprises a ferrule 12, a plurality of conductor pins 13a-13i, a capacitor 14, a spacer portion 15, a solder bead 16 and a plurality of solder preforms 18a-18h.

The assembly 10 may be manufactured in the following manner. Feedthrough pins 13a-13i are inserted through ferrule 12. In one direction, feedthrough pins 13a-13i extend outside the implanted medical device (not shown), which is hermetically sealed with the bottom portion 12a of the ferrule 12. In the opposite direction, conductor pins 13a-13i extend through a spacer portion 15 and capacitor 14 and into the internal portion of the medical device. The spacer portion 15 provides support for the capacitor 14, and may also inhibit or reduce the flow of solder into the hermetically sealed part of the feedthrough. Once the spacer portion 15 and capacitor 14 are positioned within the top portion 12b of the ferrule 12, electrical connections between the capacitor 14 and conductor pins 13a-13h may be formed.

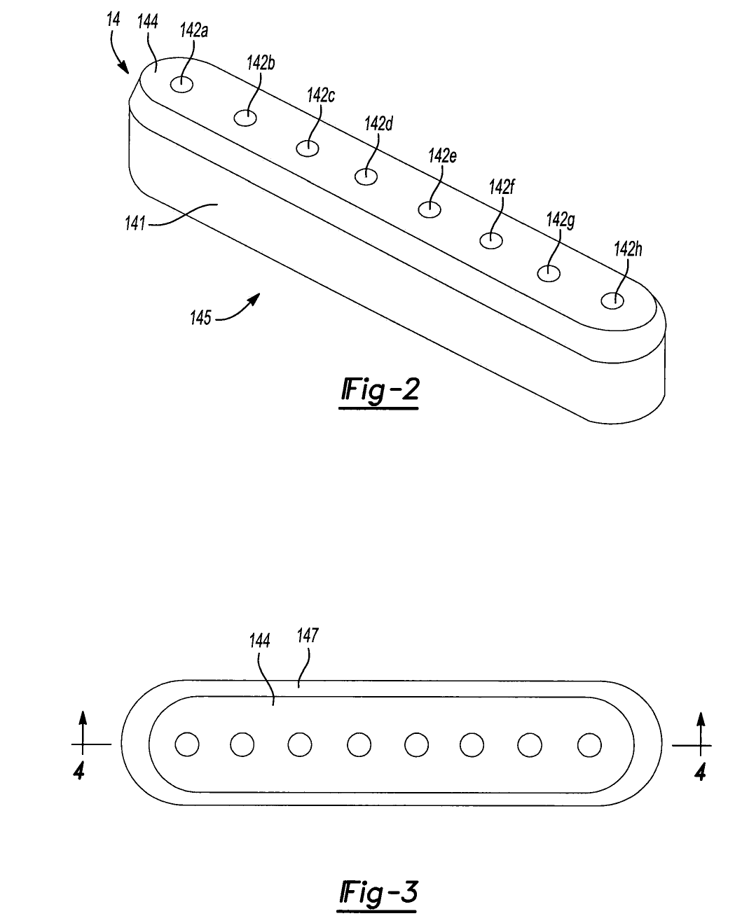

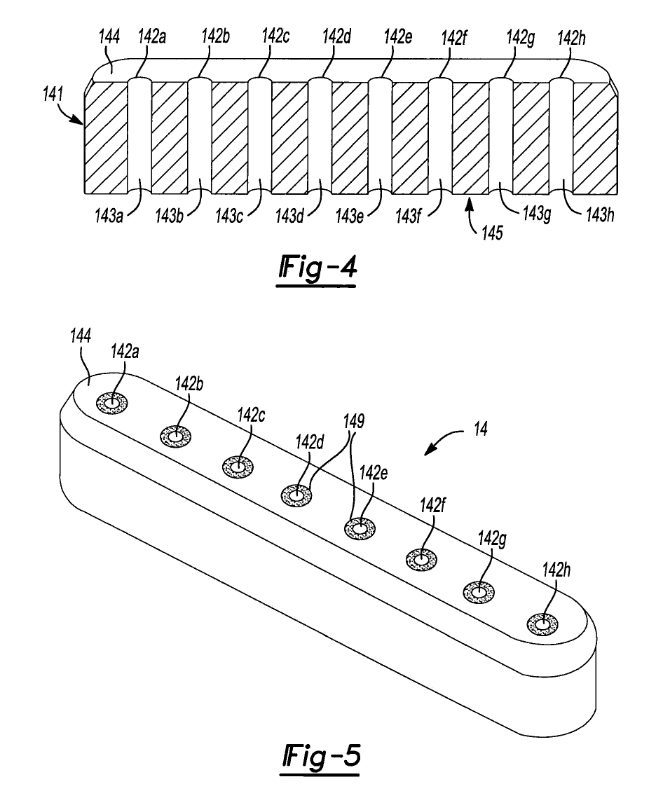

Referring now to FIGS. 2-4, a capacitor 14 according to various embodiments of the present disclosure is illustrated. The capacitor 14 includes an outer diameter portion 141 that may substantially surround the capacitor 14, a top portion 144 and bottom portion 145. A plurality of feedthrough holes 142a-142h may extend completely through the body of the capacitor 14 to provide an opening between top portion 144 and bottom portion 145. As best illustrated in FIG. 4, inner diameter portion or portions 143a-143h are present in the capacitor 14, and, thus, define the plurality of feedthrough holes 142. The outer diameter portion 141 and inner diameter portion 143 are each connected to one of the two sets of electrode plates that comprise the capacitor 14 and are electrically isolated from one another. In the capacitor feedthrough assembly of FIG. 1, the outer diameter portion 141 is electrically coupled to the ferrule 12 by means of solder bead 16 and the inner diameter portion 143 is coupled to the conductor pins 13a-13h by solder preforms 18a-18h.

A reliable electrical connection between the outer diameter portion 141 and ferrule 12 may be made by the solder bead 16. In one method of assembly according to various embodiments of the present disclosure, the solder bead 16 is placed on top of the capacitor 14 within the top portion 12b of ferrule 12. A chamfer 147 may be formed on the top portion 144 of capacitor 14. The chamfer 147 will bias the placement of solder bead 16 such that proper placement of solder bead 16 is assured. Solder preforms 18a-18h may comprise circular or semi-circular rings of solder material, although the use of other shapes (square, rectangular, triangular, etc.) for the solder preforms 18a-18h are within the scope of this disclosure. Each of the solder preforms 18a-18h receive one of the conductor pins 13a-13h such that the solder preform 18 rests on the top portion 144 of capacitor 14. Once the solder beads 16 and solder preforms 18 are present on the capacitor 14, a solder reflow process is performed, which is described more fully below, in which heat is applied to melt the solder bead 16 and solder preforms 18 in order to electrically connect the ferrule 12 with the outer diameter portion 141 and conductor pins 13 to the inner diameter portion 143.

In various embodiments, solder preforms 18a-18h may comprise fluxless solder. As described above, oxidation may create an oxide layer on the solder preforms, which will inhibit a reliable electrical connection. An oxide layer on the solder preform, and/or oxide formed on the capacitor 14, will inhibit the flow of the solder into the holes 142a-142h and, thus, may lead to inconsistent or imperfect connections between the inner diameter portion 143h and conductor pins 13e-13i of the capacitor feedthrough assembly 10. In order to ensure adequate flow of the solder, a conductive pad 149 of conductive material, e.g., gold, may be formed on the top portion 144 of the capacitor 14 surrounding each of the holes 142a-142h, as shown in FIG. 5. The conductive pad may be applied to the top portion 144 by any means, including, but not limited to, sputtering, manual application, screen printing, ink jet printing, or even application of the capacitor termination material present on the inner diameter portion 143. The presence of the conductive pad 149 provides an enhanced flow of solder from the solder preform 18 into the holes 142 of the inner diameter portion 143 surrounding the conductor pins 13, even if the solder preform has an oxide layer formed on its outside.

Once the capacitor/feedthrough assembly is assembled and the solder bead 16 and solder preforms 18a-18h are present on the capacitor 14, a solder reflow process is performed. The solder reflow process liquefies the solder bead 16 and solder preforms 18 such that solder flows to electrically connect the outer diameter portion 141 and inner diameter portion 143 to the ferrule 12 and conductor pins 13, respectively. The presence of the conductive pads 149 enhance the solder flow such that the connection between the conductor pins 13 and inner diameter portion 143 of capacitor 14 is ensured.

Solder bead 16, in various embodiments of the present disclosure, may be replaced by a different conductive adhesive, e.g., conductive epoxy or brazing. Furthermore, as stated above, the conductive pads may be formed of any conductive material, e.g., gold, silver or silver-palladium. The conductive pads may be formed during the capacitor manufacturing process or may be added to a fully formed capacitor after its manufacture. The solder preforms 18 may be circular of a washer-shaped construction in which the inner diameter is only slightly larger than the diameter of the conductor pins 13 such that proper placement of the solder preforms 18 surrounding the conductor pins 13 is assured. In various embodiments, a counterbore or countersink may be formed around the holes 142 of the capacitor 14 to further assist in the placement of the solder preforms 18, similar to the chamfer 147 present on the outer diameter portion 141 in FIG. 1.

The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A filtered feedthrough assembly, comprising:
a capacitor comprising a top portion, a bottom portion, an outer diameter portion and an inner diameter portion, wherein said inner diameter portion defines at least one aperture extending from the top portion to the bottom portion and a conductive pad of conductive material is applied to the top portion around the at least one aperture; and
at least one feedthrough pin extending through the at least one aperture, wherein the at least one feedthrough pin is soldered to the inner diameter portion of the capacitor by application of a solder preform upon the conductive pad of conductive material.

2. The filtered feedthrough assembly of claim 1, wherein the conductive material comprises one of gold, silver, silver-palladium, platinum, platinum-iridium, gold-beryllium, copper, copper-beryllium, nickel, titanium and a combination thereof.

3. The filtered feedthrough assembly of claim 1, further comprising a ferrule coupled to the outer diameter portion of the capacitor.

4. The filtered feedthrough assembly of claim 3, wherein the ferrule is coupled to the outer diameter portion of the capacitor by placement of a conductive bead proximate the outer diameter portion and ferrule.

5. The filtered feedthrough assembly of claim 4, wherein the capacitor further comprises an outer diameter chamfer extending between the outer diameter portion and the top portion and the conductive bead is placed proximate the outer diameter chamfer.

6. The filtered feedthrough assembly of claim 5, further comprising a spacer placed within the ferrule and supporting the capacitor.

7. The filtered feedthrough assembly of claim 1, wherein the conductive pad of conductive material is applied to the top portion of the capacitor by one of sputtering, manual application, screen printing, ink jet printing and a combination thereof.

8. The filtered feedthrough assembly of claim 1, wherein the capacitor further comprises an inner diameter counterbore extending between the inner diameter portion and the top portion and the solder preform is placed proximate the inner diameter counterbore.

9. The filtered feedthrough assembly of claim 1, wherein the solder preform surrounds the at least one feedthrough pin.

10. A method of manufacturing a filtered feedthrough assembly, comprising:
applying a conductive pad of conductive material to a capacitor, the capacitor comprising a top portion, a bottom portion, an outer diameter portion and an inner diameter portion, wherein said inner diameter portion defines at least one aperture extending from the top portion to the bottom portion and the conductive pad of conductive material is applied to the top portion around the at least one aperture;
extending a feedthrough pin through the at least one aperture;
placing a solder preform upon the conductive pad of conductive material; and
soldering the feedthrough pin to the inner diameter portion of the capacitor with the solder preform.

11. The method of claim 10, wherein the conductive material comprises one of gold, silver, silver-palladium, platinum, platinum-iridium, gold-beryllium, copper, copper-beryllium, nickel, titanium and a combination thereof.

12. The method of claim 10, further comprising coupling a ferrule to the outer diameter portion of the capacitor.

13. The method of claim 12, further comprising placing a conductive bead proximate the outer diameter portion, wherein the ferrule is coupled to the outer diameter portion of the capacitor by the conductive bead.

14. The method of claim 13, wherein the capacitor further comprises an outer diameter chamfer extending between the outer diameter portion and the top portion and the conductive bead is placed proximate the outer diameter chamfer.

15. The method of claim 14, further comprising placing a spacer within the ferrule, wherein the spacer supports the capacitor.

16. The method of claim 10, wherein the conductive pad of conductive material is applied to the top portion of the capacitor by one of sputtering, manual application, screen printing, ink jet printing and a combination thereof.

17. The method of claim 10, wherein the capacitor further comprises an inner diameter counterbore extending between the inner diameter portion and the top portion and the solder preform is placed proximate the inner diameter counterbore.

18. The method of claim 10, wherein the solder preform surrounds the at least one feedthrough pin.
